(19) United States
(12) Patent Application Publication
(10) Pub. No.: US 2016/0125005 A1
(43) Pub. Date: May 5, 2016

(54) Apparatus and Method for Profiling Activities and Transitions

(71) Applicant: The Johns Hopkins University, Baltimore, MD (US)

(72) Inventors: Cetin A. Savkli, Annapolis, MD (US); Michael D. Lieberman, Silver Spring, MD (US)

(21) Appl. No.: 14/923,860

(22) Filed: Oct. 27, 2015

Related U.S. Application Data
(60) Provisional application No. 62/072,537, filed on Oct. 30, 2014.

(51) Int. Cl. G06F 17/30

(52) U.S. Cl. CPC G06F 17/30321; G06F 17/30958; G06F 17/30327

(57) ABSTRACT

A method and apparatus for generating a structured profile of activities and transitions is provided. The method includes receiving data related to a plurality of activities and a plurality of transitions, wherein each of the plurality of transitions is a path between a pair of activities among the plurality of activities, storing the data related to the plurality of activities and the plurality of transitions into the storage device, reducing a dimension of the data by indexing the data using state variables, generating a plurality of nodes, wherein each of the plurality of nodes corresponds to each of the plurality of activities, generating a plurality of links, wherein each of the plurality of links corresponds to each of the plurality of transitions, and storing the plurality of nodes and the plurality of links as the structured profile at the storage device.

### CROSS REFERENCE TO RELATED APPLICATIONS

This application claims the benefit of U.S. Provisional Application No. 62/072,537 filed on Oct. 30, 2014, the entire contents of which are hereby incorporated herein by reference.

### TECHNICAL FIELD

Example embodiments generally relate to data processing and, in particular, relate to generating a structured profile of activities and transitions to analyze the activities and the transitions.

### BACKGROUND

Graphs provide a flexible data structure that facilitates fusion of disparate data sets. The popularity of graphs has shown a steady growth with the development of internet, cyber, and social networks. While graphs provide a flexible data structure, processing and analysis of large graphs remains a challenging problem. Successful implementation of graph analytics revolves around several key considerations: rapid data ingest and retrieval, scalable storage, and parallel processing.

Graphs may be used to automatically detect activity patterns of behavior in a complex data set that involve activities of individuals and entities, and data associated with the activities, including transitions between the activities. A challenge for automatically detecting activity patterns is that the complex data set involves sequences of activities as well as attributes/states of entities and individuals. Some anomalies are associated with behaviors of multiple entities and correlations between the behaviors, while some anomalies are associated with activity sequences that are non-consecutive (interlaced with other events in between). Therefore, analysts are often even not sure about what sequences of events to look for to detect patterns and anomalies.

Existing approaches to detect patterns of behavior using graphs have various simplifying assumptions. In the temporal approach, activities are sequential and each activity only depends on what precedes the current activity (i.e., Markov chains). The goal of the temporal approach is usually to estimate state based on linear activity sequences. This approach does not accommodate input about entity/environment state information and individual states are independently evaluated. In the state based approach, problem can be represented as a state in a high dimensional attribute space. Bayesian networks are the most commonly used approach. In this approach, time is usually handled as an afterthought by creating temporal state variables. This approach does not provide a natural way to store information about the sequences in which a state was reached. Activities can only be incorporated if represented as state variables, still not accounting for temporal order.

### BRIEF SUMMARY OF SOME EXAMPLES

Accordingly, some example embodiments may enable analyzing activities and associated data as described below. In one example embodiment, an apparatus is provided for generating a structured profile of activities and transitions including processing circuitry and a storage device. The processing circuitry is configured to receive data related to a plurality of activities and a plurality of transitions, wherein each of the plurality of transitions is a path between a pair of activities among the plurality of activities, store the data related to the plurality of activities and the plurality of transitions into the storage device, reduce dimension of the data by indexing the data using state variables, generate a plurality of nodes, wherein each of the plurality of nodes corresponds to each of the plurality of activities, generate a plurality of links, wherein each of the plurality of links corresponds to each of the plurality of transitions, and store the plurality of nodes and the plurality of links as the structured profile at the storage device.

Here, the processing circuitry is further configured to form a tree structure from the plurality of nodes and the plurality of links.

Here, the processing circuitry is further configured to group, before generating the plurality of nodes and the plurality of links, the plurality of activities and the plurality of transitions according to a plurality of attributes, generate a plurality of tree structures for each of a plurality of attributes, calculate entropy-based metric for each of the plurality of tree structures to measure quality of the each of the plurality of tree structures, determine a most informative tree structure according to the calculated entropy-based metric, and determine a most informative attribute corresponding to the most informative tree structure.

In another example embodiment, a method for generating a structured profile of activities and transitions is provided including receiving data related to a plurality of activities and a plurality of transitions, wherein each of the plurality of transitions is a path between a pair of activities among the plurality of activities, storing the data related to the plurality of activities and the plurality of transitions into the storage device, reducing a dimension of the data by indexing the data using state variables, generate a plurality of nodes, wherein each of the plurality of nodes corresponds to each of the plurality of activities, generating a plurality of links, wherein each of the plurality of links corresponds to each of the plurality of transitions, and storing the plurality of nodes and the plurality of links as the structured profile at the storage device.

Here, the method further includes forming a tree structure from the plurality of nodes and the plurality of links.

Here, the method further includes grouping, before generating the plurality of nodes and the plurality of links, the plurality of activities and the plurality of transitions according to a plurality of attributes, generating a plurality of tree structures for each of a plurality of attributes, calculate entropy-based metric for each of the plurality of tree structures to measure quality of the each of the plurality of tree structures, determine a most informative tree structure according to the calculated entropy-based metric, and determine a most informative attribute corresponding to the most informative tree structure.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of an apparatus for creating a structured profile of activities and transitions according to an example embodiment;

FIG. 2 is an exemplary structured tree comprising nodes and links corresponding to activities and transitions;

FIG. 3 is a flow chart to depict an exemplary embodiment for generating a structured profile according to the present invention;

FIG. 4 is an exemplary visual representation of a structured profile according to an example embodiment;

FIG. 5 is a flow chart to depict another exemplary embodiment for generating a plurality of structured profile for each of attributes and determine a most informative attribute among the attributes;

FIG. 6A is an exemplary graph that shows a result of calculated entropy-based metrics of a plurality of structured profile according to an example embodiment;

FIG. 6B is exemplary visual representations of structured profiles that visualize a minimum informative structured profile and a maximum informative structured profile according to an example embodiment;

FIGS. 7A to 7E are conceptual diagrams to depict an exemplary embodiment to reduce dimension of complex data set according to an example embodiment;

FIG. 8 is a diagram to depict an exemplary processing to reduce a dimension of complex data set according to an example embodiment; and

FIG. 9 is a conceptual diagram that shows how the structured profiles may be used to identify entities showing similar behaviors according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

The term “activity” as used herein shall be interpreted to mean representation of a specific behavior of an individuals or entity. An entity may be any identifiable person, place, or thing existing digitally or in reality, for example a person, flight, document, email, geographical location, computer, vehicle, or the like. An activity may be any behavior, for example walking, running, flying, or landing, or the like.

The term “transition” as used herein shall be interpreted to mean a path between two activities, e.g., “walking-runs-running” where “walking” and “running” represent activities and “runs” represents that an individual starts running from walking.

The term “node” as used herein shall be interpreted to mean a point at which links or pathways intersect in a graph.

The term “link” as used herein shall be interpreted to mean a path connecting a pair of nodes in a graph.

The term “graph” as used herein shall be interpreted to mean a structure representing nodes and associated links.

Some example embodiments may provide an apparatus and method which analyze activities and transitions from a complex data set by using a tree structure comprising nodes and links corresponding to the activities and the transitions respectively. The method combines the key features of the temporal approach and the state-based approach and avoids the problems discussed above in regards to each. In some example embodiments of the method, activities and transitions are modeled as nodes and links in a structured graph, in order to reducing dimensions of the complex data set through clustering.

The method may be beneficial for analyzing complex data set having multiple attributes. Example embodiment of the present invention reduces dimensionability of data set through clustering and building a tree that represents patterns of behavior for actors. Tree nodes represent activities and link representing transitions between activities. Links store information about probability of a transition as well as statistical parameters of the transition (e.g., a mean time and a standard deviation). The method allows generation of activity trees for a population, a subgroup or an individual, therefore allowing a finely tuned analysis of behavior patterns in any group.

Example embodiments of the present invention can be used for multiple purposes. The first use involves detection of anomalies in data. Anomalies can be in either in existing data or newly observed data. Anomalies in a group may answer questions such as who in the group is behaving in an unusual way and what their activities are. When used on a specific individual, the method can help detect anomalous behavior changes in the individual. This is particularly useful capability for detecting insider activity. The second use is providing estimates about activities not yet observed. As the method captures probabilities of activity sequences, one can get estimates about the probability and the expected time of the next activity in the sequences.

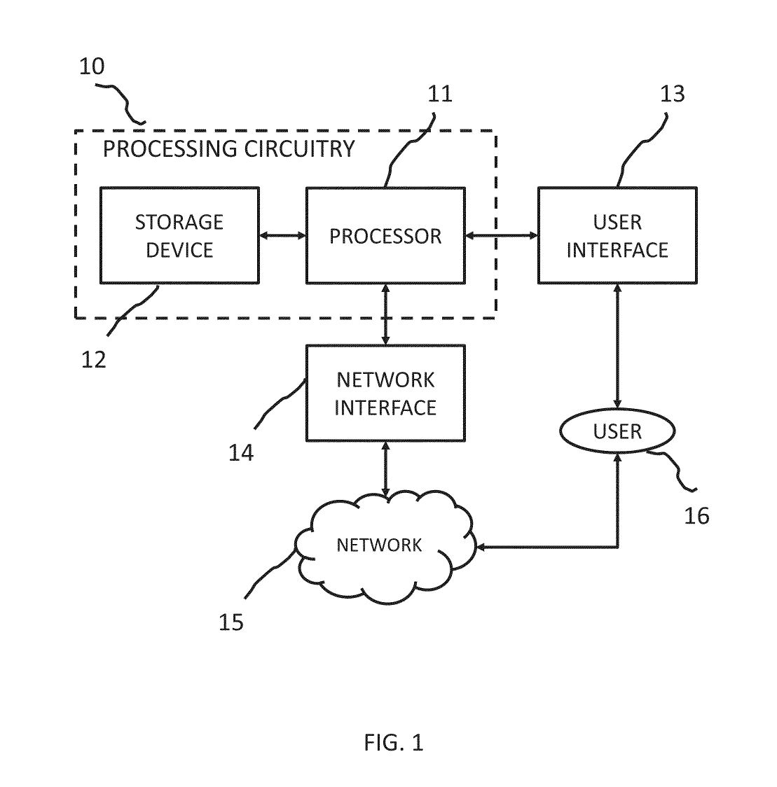

An example embodiment of the invention will now be described in reference to FIG. 1. FIG. 1 shows certain elements of an apparatus for analyzing activities and transitions according to an example embodiment. The apparatus of FIG. 1 may be employed, for example, on a client (e.g., a server, a workstation, or the like) or a variety of other devices (such as, for example, a network device, proxy, or the like. Alternatively, embodiments may be employed on a combination of devices. Accordingly, some embodiments of the present invention may be embodied wholly at a single device or by devices in a client/server relationship. Furthermore, it should be noted that the devices or elements described below may not be mandatory and thus some may be omitted in certain embodiments.

Referring now to FIG. 1, an apparatus configured for analyzing activities and transitions is provided. The apparatus may be an embodiment of processing circuitry 10 that is configured to perform data processing, application execution and other processing and management services according to an example embodiment of the present invention. In one embodiment, the processing circuitry 10 may include a storage device 12 and a processor 11 that may be in communication with or otherwise control a user interface 13 and a network interface 14. As such, the processing circuitry 10 may be embodied as a circuit chip (e.g., an integrated circuit chip) configured (e.g., with hardware, software or a combination of hardware and software) to perform operations described herein. However, in some embodiments, the processing circuitry 10 may be embodied as a portion of a server, computer, laptop, workstation or even one of various mobile computing devices. In situations where the processing circuitry 10 is embodied as a server or at a remotely located computing device, the user interface 13 may be disposed at another device (e.g., at a computer terminal or client device such as one of the clients 20) that may be in communication with the processing circuitry 10 via the network interface 14 and/or a network (e.g., network 15).

The user interface 13 may be in communication with the processing circuitry 10 to receive an indication of a user input from a user 16 at the user interface 13 and/or to provide an audible, visual, mechanical or other output to the user. As such, the user interface 13 may include, for example, a keyboard, a mouse, a joystick, a display, a touch screen, a microphone, a speaker, a cell phone, or other input/output mechanisms. In embodiments where the apparatus is embodied at a server or other network entity, the user interface 13 may be limited or even eliminated in some cases. Alternatively, as indicated above, the user interface 13 may be remotely located.

The network interface 14 may include one or more interface mechanisms for enabling communication with other devices and/or networks. In some cases, the network interface 14 may be any means such as a device or circuitry embodied in either hardware, software, or a combination of hardware and software that is configured to receive and/or transmit data from/to a network and/or any other device or module in communication with the processing circuitry 10. In this regard, the network interface 14 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the network interface 14 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 12 may include one or more non-transitory storage or memory devices such as, for example, volatile and/or non-volatile memory that may be either fixed or removable. The storage device 12 may be configured to store information, data, applications, instructions or the like for enabling the apparatus to carry out various functions in accordance with example embodiments of the present invention. For example, the storage device 12 could be configured to buffer input data for processing by the processor 11. Additionally or alternatively, the storage device 12 could be configured to store instructions for execution by the processor 11. As yet another alternative, the storage device 12 may include one of a plurality of databases that may store a variety of files, contents or data sets. Among the contents of the storage device 12, applications may be stored for execution by the processor 11 in order to carry out the functionality associated with each respective application.

The processor 11 may be embodied in a number of different ways. For example, the processor 11 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 11 may be configured to execute instructions stored in the storage device 12 or otherwise accessible to the processor 11. As such, whether configured by hardware or software methods, or by a combination thereof, the processor 11 may represent an entity (e.g., physically embodied in circuitry) capable of performing operations according to embodiments of the present invention while configured accordingly. Thus, for example, when the processor 11 is embodied as an ASIC, FPGA or the like, the processor 11 may be specifically configured hardware for conducting the operations described herein. Alternatively, as another example, when the processor 11 is embodied as an executor of software instructions, the instructions may specifically configure the processor 11 to perform the operations described herein.

In an example embodiment, generating a structured profile of activities and transitions includes processing circuitry and a storage device. The processing circuitry is configured to receive information related to a plurality of activities and a plurality of transitions, wherein each of the plurality of transitions is a path between a pair of activities among the plurality of activities, store the information related to the plurality of activities and the plurality of transitions into the storage device, generate a plurality of nodes, wherein each of the plurality of nodes corresponds to each of the plurality of activities, generate a plurality of links, wherein each of the plurality of links corresponds to each of the plurality of transitions, and store the plurality of nodes and the plurality of links as the structured profile at the storage device.

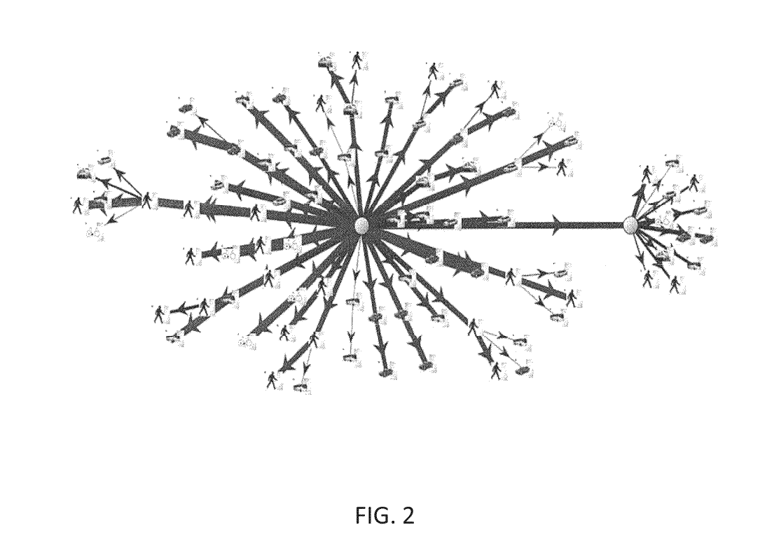

FIG. 2 is an exemplary structured profile comprising nodes and links corresponding to activities and transitions.

Referring to FIG. 2, each nodes of the structured profile represents an activity. Activity represents a specific behavior or a state of an individuals or entity. An activity may be, for example walking, running, flying, or landing, or the like. Each link represents a path or a transition from an activity to another activity. A transition may be, for example, start running, or taking off, or the like.

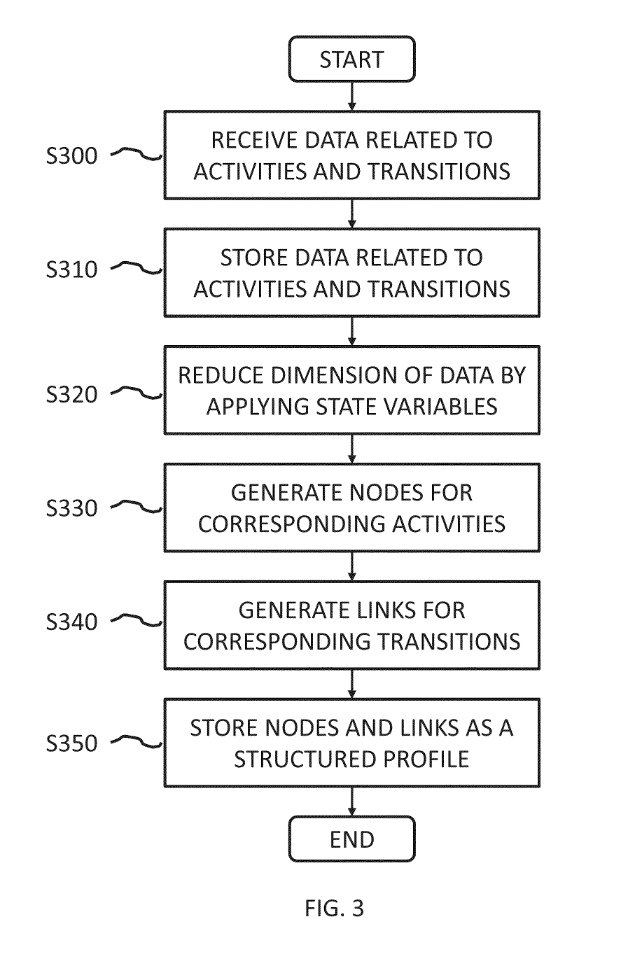

FIG. 3 is a flow chart to depict an exemplary embodiment for generating a structured profile according to the present invention.

Referring to FIG. 3, the processing circuitry 10 may perform generating a structured profile of activities and transitions. The processing circuitry 10 may receive data related to activities and transitions from a user 22 using a user interface 20 (S300). The user 22 may enter the data related to the activities and the transitions in the user interface 20. Alternately, the user 22 may upload a file containing the data on the activities and the transitions using the user interface 20.

The processing circuitry 10 stores the received data related to the activities and the transitions into a storage device 14 (S310). Alternately, the processing circuitry 10 may store the data related to the activities and the transitions into an external storage device that is not disclosed in the figures. The information related to the activities and the transitions may be stored in a table of a database or in any other type of storage. The information related to the transitions may have a starting activity and an ending activity for the transition.

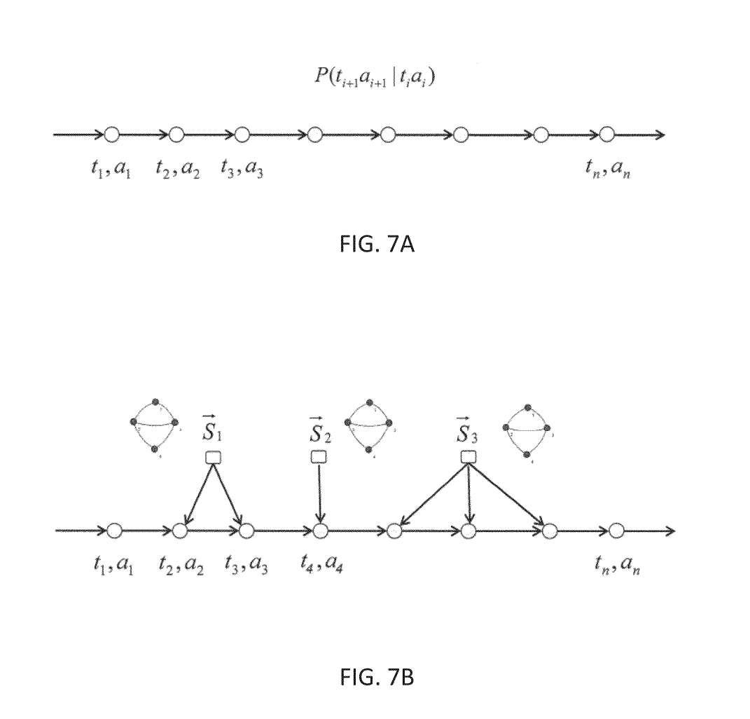

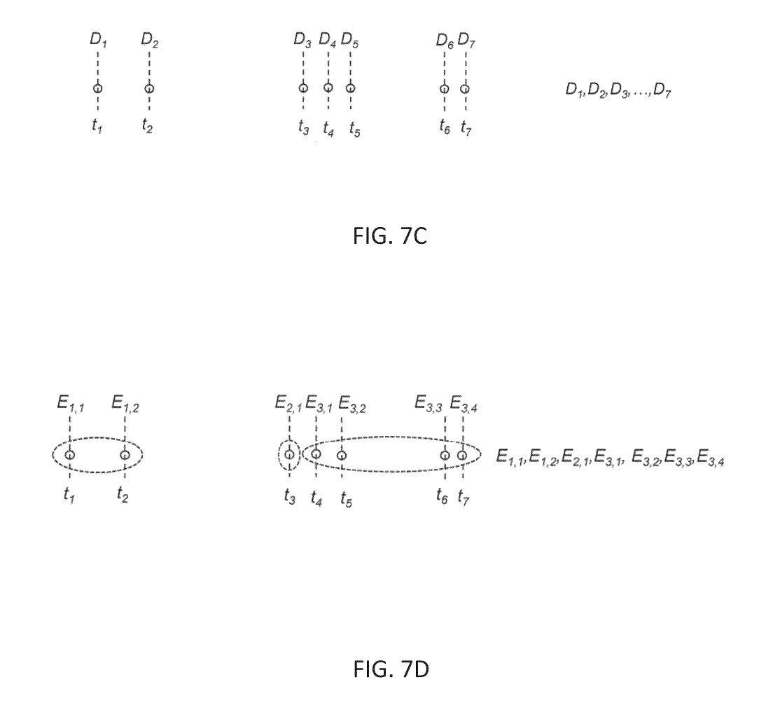

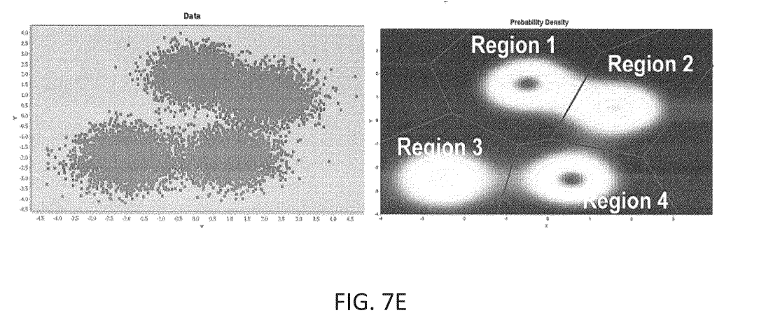

The processing circuitry 10 reduces a dimension of the data by indexing the data using state variables (S320). The received data related to activities and transitions may have values in continuum, which means that the values may be continuous from each other. Indexing the data using state variables converts the continuous data to finite set of discrete values. For example, FIG. 7E shows an exemplary embodiment of converting 2-dimensional data in continuum with infinitely possible values into 1-dimensional data with a limited number of values.

The processing circuitry 10 accesses the information related to the activities and generates a node for each of the plurality of activities (S330). A node may be implemented as a record in a table of the database. The record in the table may have additional information to manage the records. For example, the record may have a unique identifier to identify the node, a name of the corresponding activity, a type of the activity, graphical information to manage the node in a tree graph, or any other necessary information.

The processing circuitry 10 accesses the information related to the transitions and generates a link for each of the plurality of transitions (S340). A link may be implemented as a record in a table of the database. The record in the table may have additional information related to the corresponding transition. For example, the record may have a unique identifier to identify the link, a name of the corresponding transition, a unique identifier of the starting node and a unique identifier of the ending node, a type of the transition, graphical information to manage the link in the tree graph, or any other necessary information.

Furthermore, the additional information related to the transition may include a probability score for the transition. The probability score may be a simple probability with which the transition happens. Alternately, the probability score may be a modified probability (e.g., weighted according to a certain factor). In addition, the additional information may include statistical parameters related to the transition (e.g., mean time, standard deviation, or the like).

The processing circuitry 10 further stores information on the generated nodes and links into the storage device 14 (S350). Alternately, the processing circuitry 10 may store the information related to the generated nodes and links into the external storage device that is not disclosed in the figures. The information related to the nodes and the links may be stored in a table of a database or in any other type of storage. The information to the nodes and the links may be stored as a tree structure.

The processing circuitry 10 may generate a structured profile of activities and transitions by using only the data belongs to a given time window. Any data that created outside of the given time window may be filtered out when generating the structured profile.

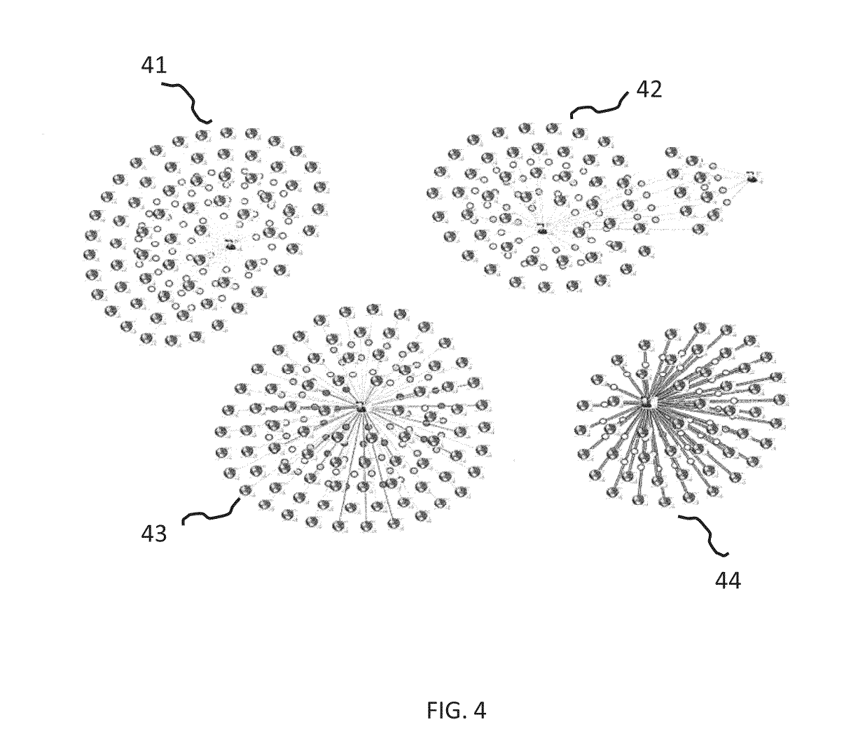

FIG. 4 is an exemplary visual representation of a structured profile according to the present invention.

Referring to FIG. 4, the processing circuitry 10 processes the received information on activities and transitions. The processing circuitry 10 generates a plurality of nodes 41 from the plurality of activities (S330). Each node of the plurality of nodes corresponds to each respective activity. The processing circuitry 10 further generates a plurality of links from the plurality of transitions (S340), and each of the links connects corresponding nodes 42. As more data related to additional activities and transitions are collected, the processing circuitry 10 generates more nodes and links 43, 44.

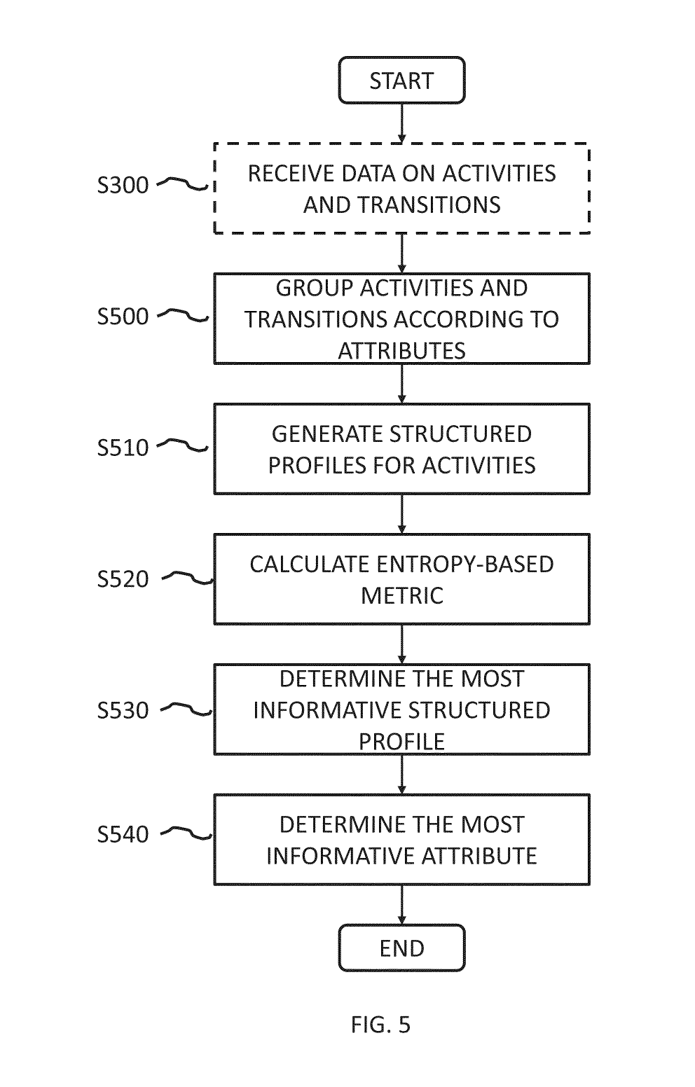

FIG. 5 is a flow chart to depict another exemplary embodiment for generating a plurality of structured profile for each of attributes and determine a most informative attribute among the attributes according to the present invention.

Referring to FIG. 5, the processing circuitry 10 groups the plurality of activities and the plurality of transitions according to a plurality of attributes of the entries and individuals (S500). The attributes of the entries and individuals may be any characteristic of the entries and individuals which related data is collected and stored. For example, for a human, weight and hair color may be attributes of interest. For a plane, wind speed or a number of passengers may be attributes of interest.

As the number of attributes that are collected and managed is increased, it becomes more difficult to analyze relationships between detect patterns and collected complex data of the entries and individuals. Therefore, it is important to determine what the most informative attribute is and analyze patterns and relationships for the entities and individuals for the most informative attribute.

The processing circuitry 10 generates a structured profile for each of the attributes from the grouped activities and transitions. (S510). The generating of the structured profiles use the process depicted in FIG. 3.

The processing circuitry 10 calculates an entropy-based metric for each of the plurality of structured profile to measure quality of the each of the plurality of structured profile (S520). An entropy measure may be qualitatively used to classify information content of behavior profiles. Entropy is a measure of uncertainty in data where high entropy indicates that the behavior profile is largely random and does not contain useful information. Selecting behavior representations based on minimum entropy results in profiles that contain maximum information.

In detail, entropy based metric U measures randomness of a tree. In an exemplary embodiment of the present invention, an entropy based metric is calculated using following Equation 1:

$${U}_{N} = {S}_{max} - S \\ S = - {\sum }_{i = 1}^{n} {p}_{i} log {p}_{i} \qquad [ Equation 1 ]$$

In Equation 1, S is a measure of randomness and U measures how much information the tree contains.

The processing circuitry 10 determines a most informative structured profile according to the calculated entropy-based metric (S530). In order to determine the most informative structured profile, the processing circuitry 10 may use visual representations of the structured profiles. For example, the processing circuitry 10 may use thickness of the links which is indicated of the probability for a corresponding transition happening. Alternately, the processing circuitry 10 may use color of the links which is indicated of the probability for a corresponding transition happening.

According to the result of determining the most informative structured profile, the processing circuitry 10 determines a most informative attribute which is corresponding to the most informative structured profile (S540).

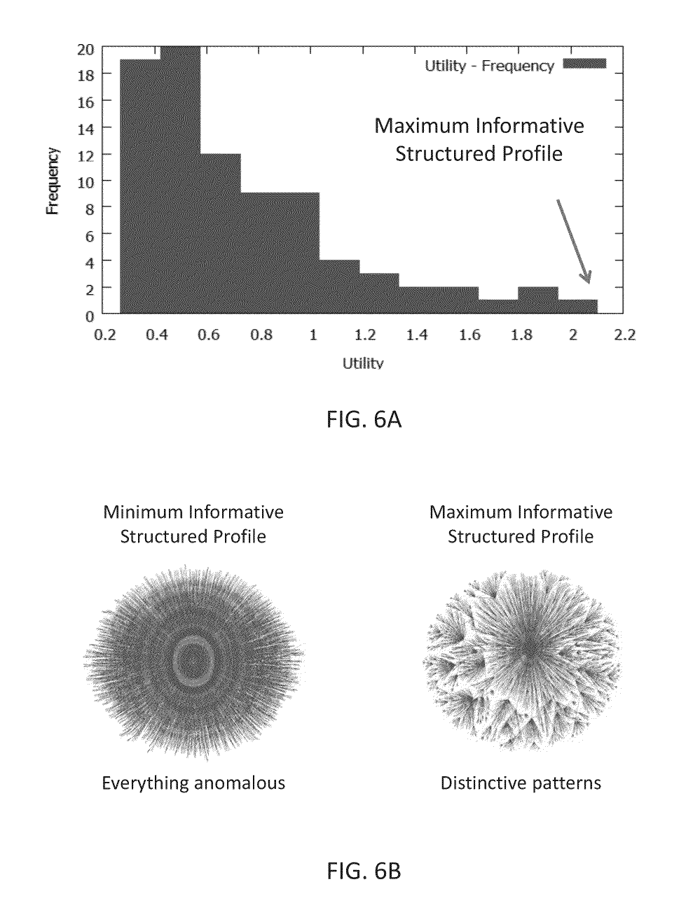

FIG. 6A is an exemplary graph that shows a result of calculated entropy-based metrics of a plurality of structured profile according to the present invention.

Referring to 6A, the graph shows calculated frequency, as an entropy-based metric, according to different values of utility. In this example, the utility value with the lowest frequency indicates the most informative structured profile.

FIG. 6B is exemplary visual representations of structured profiles that visualize a minimum informative structured profile and a maximum informative structured profile according to the present invention.

Referring to 6B, the minimum informative structured profile 62 visualizes that the structured profile does not have any distinct pattern. With this structured profile, everything is anomalous, which means that everything is normal. The maximum informative structured profile 63 visualizes that the structured profile has distinctive patterns Analyzing the distinctive patterns increase a probability to find with what activities and transitions anomalies are happening.

FIGS. 7A to 7E are conceptual diagrams to depict an exemplary embodiment to reduce dimension of complex data set according to the present invention.

Referring to FIG. 7A, the processing circuitry 10 stores activities, transitions, and probability of the transitions to detect anomalous patterns. The activities and transitions form a structured tree 71.

Referring to FIG. 7B, the processing circuitry 10 generalizes the activities in the structured tree 71 with introducing state variables. One or more activities may have a same state. For example, activity a2 and a3 may have the same state S1, while only activity a4 has the state S2.

Referring to FIG. 7C, data associated with the activities includes continuum variables, which means that each of sequence of the same activities are actually all unique, even though the same activities are involved in the same order. For example, an activity of ‘walking’ may have associated data of ‘walking on a street, on Tuesday, at 28F.’ Accordingly for each time t₁˜t₇, there are associated continuum data sets of D₁˜D₇.

Referring to FIG. 7D, instead of applying complex continuum data, the sequence of activities may be configured to be a finite set of discrete events, by applying state variables, as depicted in 7B. For example, the continuum data set of D₁˜D₇ may be replaced with the finite sets of discrete events E_{1,1}, E_{1,2}, E_{2,1}, E_{3,1}, E_{3,2}, E_{3,3}, and E_{3,4}.

Referring to FIG. 7E, by applying states and replacing continuum data with a finite set of discrete events, 2-dimensional data in continuum with infinitely many possible values may be replaced with 1-dimensional data with a finite number of possible values. FIG. 7E shows an example that replace 2-dimensional raw data to 1-dimensional data with 4 possible values.

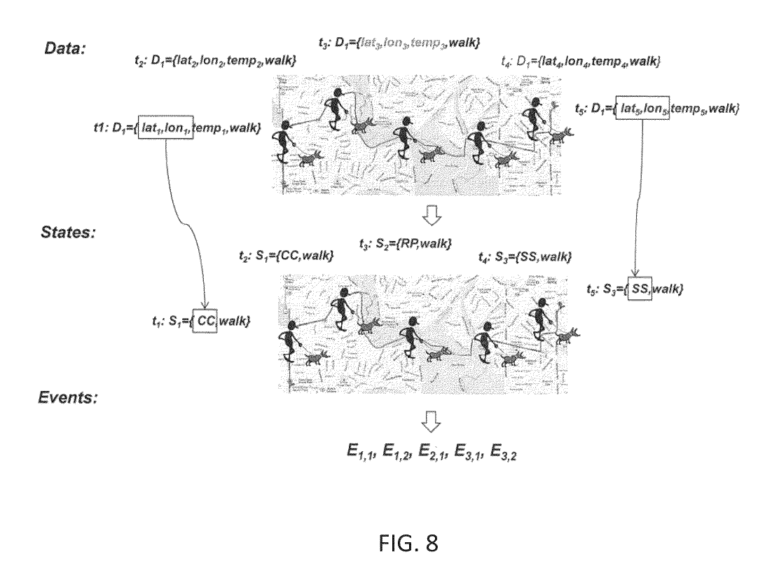

FIG. 8 is a diagram to depict an exemplary processing to reduce a dimension of complex data set according to the present invention.

Referring to FIG. 8, an individual is walking with a dog. As time goes, the individual walks at a specific latitude, a specific longitude, and a specific temperature. By applying state variables as depicted in FIGS. 7B and 7D, the combination of latitude, longitude, and temperature are replaced with a set of states (e.g., CC, RP, or SS). Accordingly, the complex data set are converted into a finite set of events or a finite number of possible values.

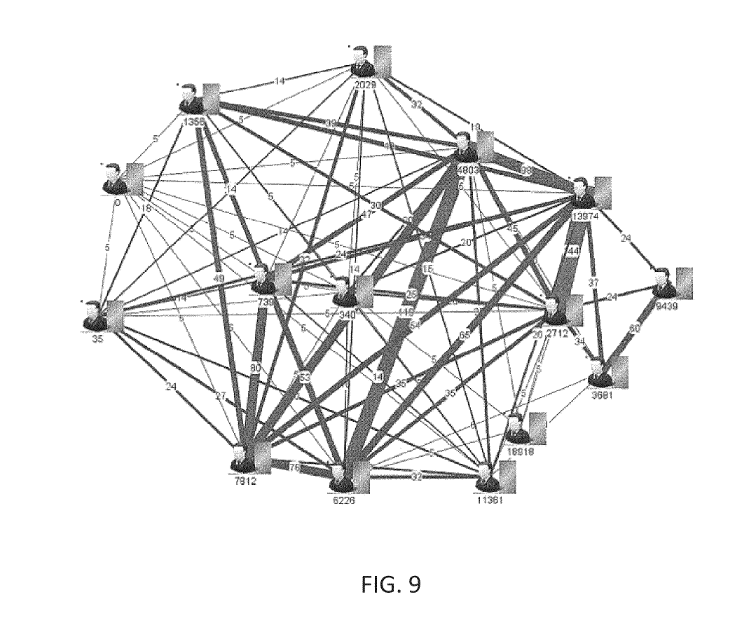

FIG. 9 is a conceptual diagram that shows how the structured profiles may be used to identify entities showing similar behaviors.

Referring FIG. 9, by analyzing how many sequences of activities separate individual entities share, a graph showing associations of individuals may be generated. Based on the graph, individuals who show similar behaviors may be identified.

According to an example embodiment, a structured profile may be generated from activities and transitions. A structured profile may be created for various group of entities, for example a population, a subgroup, or an individual, and maybe used for a finely tuned detection of anomalies in the group of entities.

According to an example embodiment, the generated structured profile may be used for estimating probabilities of likely events among the activities and transitions.

According to an example embodiment, the generated structured profile may be used for identifying behaviors of entities that show similarities.

According to an example embodiment, a dimension of complex data set may be reduced, thereby analysis of the complex data set becomes affordable even with a limited computing power.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An apparatus for generating a structured profile of a plurality of activities and a plurality of transitions, the apparatus comprising processing circuitry:
wherein the processing circuitry comprises a storage device and is configured to:
receive data related to the plurality of activities and the plurality of transitions, wherein each of the plurality of transitions is a path between a pair of activities among the plurality of activities;
store the data related to the plurality of activities and the plurality of transitions into the storage device;
reduce a dimension of the data by indexing the data using state variables;
generate a plurality of nodes, wherein each of the plurality of nodes corresponds to each of the plurality of activities;
generate a plurality of links, wherein each of the plurality of links corresponds to each of the plurality of transitions; and
store the plurality of nodes and the plurality of links as the structured profile into the storage device.

2. The apparatus of claim 1, wherein the plurality of nodes and the plurality of links form a tree structure.

3. The apparatus of claim 1, wherein each of the plurality of links includes additional data related to a corresponding transition.

4. The apparatus of claim 3, wherein the additional data includes a probability that the corresponding transition happens.

5. The apparatus of claim 3, wherein the additional data includes statistical parameters for the corresponding transition.

6. The apparatus of claim 1, wherein the processing circuitry is further configured to:
generate a visual representation for the structured profile.

7. The apparatus of claim 6, wherein thickness of each of the plurality of links in the visual representation is indicative of a probability score determined for a corresponding transition.

8. The apparatus of claim 6, wherein color of each of the plurality of links in the visual representation is indicative of a probability score determined for a corresponding transition.

9. The apparatus of claim 1, wherein the structured profile for a provided time window is generated by using the data which belongs to the provided time window.

10. The apparatus of claim 1, wherein the processing circuitry is further configured to:
group, before generating the plurality of nodes and the plurality of links, the plurality of activities and the plurality of transitions according to a plurality of attributes;
generate a plurality of structured profiles for each of a plurality of attributes;
calculate entropy-based metric for each of the plurality of structured profile to measure quality of the each of the plurality of structured profiles;
determine a most informative structured profile according to the calculated entropy-based metric; and
determine a most informative attribute corresponding to the most informative structured profile.

11. A method for generating a structured profile of a plurality of activities and a plurality of transitions, wherein the method runs on processing circuitry comprising a storage device, comprises:
receiving data related to the plurality of activities and the plurality of transitions, wherein each of the plurality of transitions is a path between a pair of activities among the plurality of activities;
storing the data related to the plurality of activities and the plurality of transitions into the storage device;
reducing a dimension of the data by indexing the data using state variables;
generating a plurality of nodes, wherein each of the plurality of nodes corresponds to each of the plurality of activities;
generating a plurality of links, wherein each of the plurality of links corresponds to each of the plurality of transitions; and
storing the plurality of nodes and the plurality of links as the structured profile into the storage device.

12. The method of claim 11, wherein the plurality of nodes and the plurality of links form a tree structure.

13. The method of claim 11, wherein each of the plurality of links includes additional data related to a corresponding transition.

14. The method of claim 13, wherein the additional data includes a probability that the corresponding transition happens.

15. The method of claim 13, wherein the additional data includes statistical parameters for the corresponding transition.

16. The method of claim 11, wherein the method further comprises:
generating a visual representation for the structured profile.

17. The method of claim 16, wherein thickness of each of the plurality of links in the visual representation is indicative of a probability score determined for a corresponding transition.

18. The method of claim 16, wherein color of each of the plurality of links in the visual representation is indicative of a probability score determined for a corresponding transition.

19. The method of claim 11, wherein the structured profile for a provided time window is generated by using the data which belongs to the provided time window.

20. The method of claim 11, wherein the method further comprises:
grouping, before generating the plurality of nodes and the plurality of links, the plurality of activities and the plurality of transitions according to a plurality of attributes;
generating a plurality of structured profiles for each of a plurality of attributes;
calculating entropy-based metric for each of the plurality of structured profile to measure quality of the each of the plurality of structured profile;
determining a most informative structured profile according to the calculated entropy-based metric; and
determining a most informative attribute corresponding to the most informative structured profile.
